(19) United States
(12) Patent Application Publication
(10) Pub. No.: US 2014/0138594 A1
(43) Pub. Date: May 22, 2014

(54) STRETCHING DEVICE

(71) Applicants: Hon Hai Percision Industry Co., Ltd., New Taipei (TW); Fu Tai Hua Industry (Shenzhen) Co., Ltd., Shenzhen (CN)

(72) Inventors: YAN-WEI LI, Shenzhen (CN); LING-HONG ZENG, Shenzhen (CN)

(21) Appl. No.: 13/909,092

(22) Filed: Jun. 4, 2013

(30) Foreign Application Priority Data
Nov. 22, 2012 (CN) 2012104773419

(51) Int. Cl. B25B 27/30

(52) U.S. Cl. CPC B25B 27/30
USPC 254/246

(57) ABSTRACT

A stretching device for moving one end of an elastic ring to a predetermined position is illustrated. The stretching device includes a base member, a handle, a movable member, a rotatable member, at least one connecting bar, and a positioning head fixed to the rotatable member. The handle includes at least one first bar, a first end of the at least one first bar being rotatably connected to the base member. The movable member is slidably mounted on the base member and comprising a blocking section opposite to the base member. The rotatable member includes at least one second bar, a first end of the at least one second bar being rotatably connected to the movable member. Opposite ends of the connecting bar are rotatably connected to a second end of the at least one first bar and a second end of the at least one second bar, respectively.

### BACKGROUND

1. Technical Field

The present disclosure relates to a stretching device for stretching one end of an elastic ring to a predetermined position.

2. Description of Related Art

Elastic rings, such as a seal ring are often assembled in electronic devices, such as a tablet computer. Since the elastic rings are easily curled, it is difficult to stretch the elastic rings before assembling them in the electronic device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a stretching device according to an exemplary embodiment.

FIG. 2 is an exploded, isometric view of the stretching device of FIG. 1.

FIGS. 3-5 are side views of the stretching device showing three different states of the stretching device of FIG. 1.

### DETAILED DESCRIPTION

Embodiments of the present disclosure are now described in detail, with reference to the accompanying drawings.

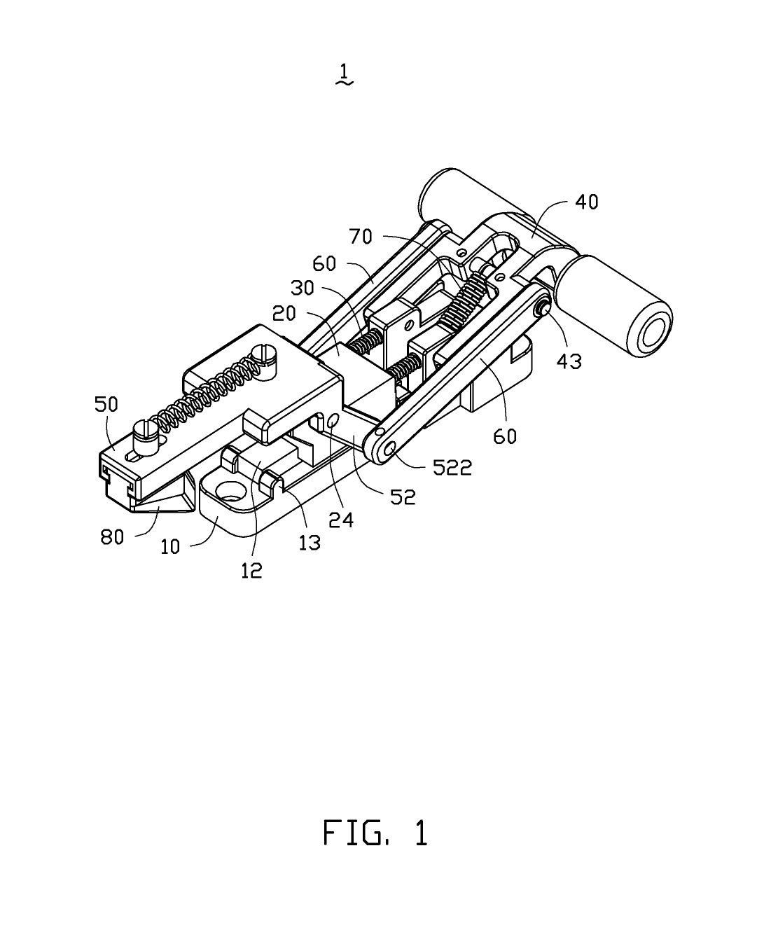

FIG. 1 is a stretching device 1 according to an exemplary embodiment. The stretching device 1 includes a base member 10, a movable member 20, a first resilient element 30, a handle 40, a rotatable member 50, two connecting bars 60, a second resilient element 70, and a positioning head 80. The stretching device 1 is used to stretch one end of an elastic ring (not shown) to a predetermined position.

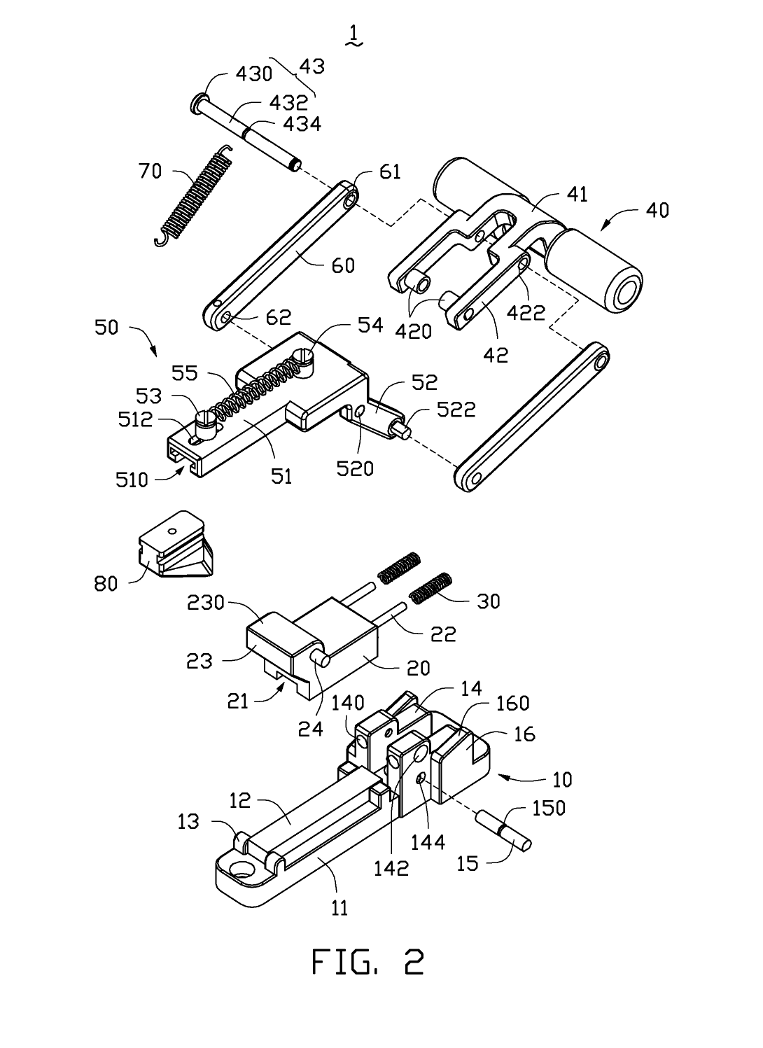

FIG. 2 shows that the base member 10 includes an elongated base portion 11, a sliding bar 12, two pairs of limiting blocks 13, two support plates 14, a fixing rod 15, and two limiting plates 16. The sliding bar 12, the limiting blocks 13, the support plates 14, and the limiting plates 16 protrude from the base portion 11. The sliding bar 12 and the limiting plates 16 are respectively located at opposite sides of the support plates 14. The limiting blocks 13 are adjacent to opposite ends of the sliding bar 12. The two support plates 14 are spaced from each other and each defines a guide hole 140. Each support plate 14 further defines two aligned first shaft holes 142 and two aligned through holes 144. The fixing rod 15 extends through the through holes 144 of the support plate 14 and defines an annular first fixing slot 150 in its lateral surface. The limiting plate 16 includes a second top surface 160.

The movable member 20 defines a sliding groove 21 in its bottom surface and includes two parallel guide pins 22 protruding form its back surface, a protruding portion 23 protruding from its top surface, and two second shaft 24 respectively protruding from opposite sides of the protruding portion 23. The sliding bar 12 of the base member 10 is received in the sliding groove 21, and the guide pins 22 are inserted into the guide holes 140 of the support plate 14. Thus, the movable member 20 is slidably connected the base member 10 and movable between two positions defined by the two pairs of limiting blocks 13. The protruding portion 23 includes a first top surface 230.

The first resilient elements 30 are positioned between the support plates 14 and the movable member 20. In the embodiment, the first resilient elements 30 are spring coils coiled around the guide pins 22 with opposite ends respectively abutting against the support plates 14 and the movable member 20.

The handle 40 includes a gripping portion 41, two first bars 42 connected to the gripping portion 41, and a third shaft 43. One end of each first bar 42 includes a first shaft 420, and the opposite end of each first bar 42 defines a third shaft hole 422. The first shaft 420 is rotatably retained within one of the first shaft holes 142 of the base member 10, thereby rotatably connecting the handle 40 to the base member 10. The third shaft 43 includes a head portion 430 and a shank portion 432 connected to the head portion 430. A diameter of the head portion 430 is greater than that of the shank portion 432. The shank portion 432 further defines an annular, second fixing slot 434 in its lateral surface.

The rotatable member 50 includes a top plate 51, two second bars 52 obliquely connected to opposite sides of the top plate 51, a first positioning post 53 slidably mounted on the top plate 51, a second positioning post 54 fixed on the top plate 51, and a third resilient element 55 with opposite ends respectively fixed to the first positioning post 53 and the second positioning post 54. The top plate 51 defines a sliding channel 510 in its bottom surface and an elongated through slot 512 communicating with the sliding channel 510 in its top surface. One end of the first positioning post 53 extends through the through slot 512. One end of each second bar 52 defines a second shaft hole 520, and the opposite end of each second bar 52 includes a fourth shaft 522.

The positioning head 80 is slidably received in the sliding channel 510 of the rotatable member 50 and fixed to the end of the first positioning post 53 that extends through the through slot 512. In the embodiment, a cross section of the sliding channel 510 is T-shaped for preventing the positioning head 80 from disengaging from the rotatable member 50.

One end of each connecting bar 60 defines a third shaft hole 61 aligned with the third shaft hole 422 of the handle 40, and the opposite end of the connecting bar 60 defines a fourth shaft hole 64 for the extension of the fourth shaft 522 of the rotatable member 50. The third shaft 43 extends through the third shaft holes 422 and 61, thereby rotatably connecting the handle 40 and the connecting bars 60.

Opposite ends of the second resilient element 70 are respectively connected to the base member 10 and the handle 40. In the embodiment, the second resilient element 70 is a spring coil with opposite ends respectively fixedly retained within the first fixing slot 150 of the base member 10 and the second fixing slot 434 of the handle 40, thereby preventing the handle 40 from rotating away from the rotatable member 50.

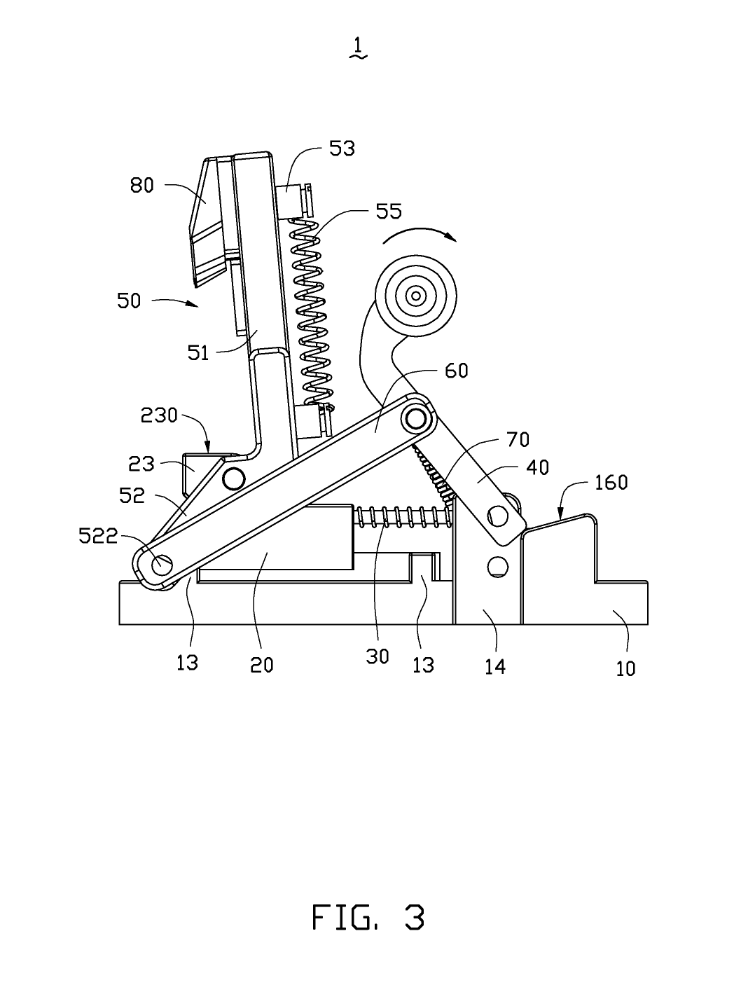

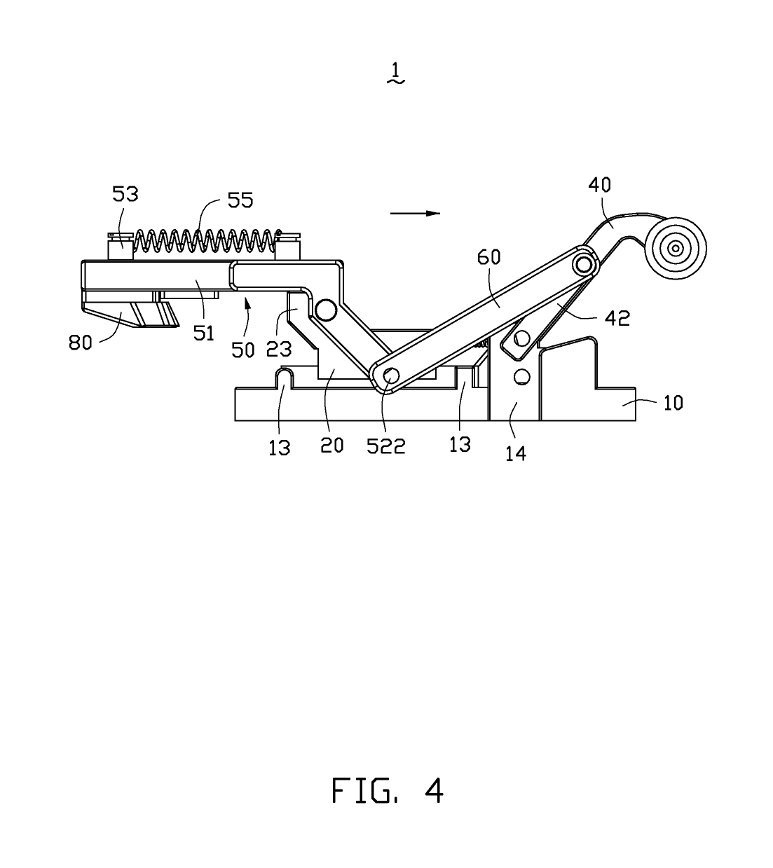

FIGS. 3 and 4 show that when the handle 40 is manually rotated clockwise, as indicated by the arrow of FIG. 3, away from the rotatable member 50, the second resilient element 70 is stretched, and the connecting bars 60 drives the rotatable member 50 to rotate with respect to the movable member 20 until the rotatable member 50 abuts against the first top surface 230 of the movable member 20. Thus, the positioning head 80 can engagingly latch one end of the elastic ring. Generally, four stretching devices 1 are simultaneously used for positioning four corners of the elastic ring.

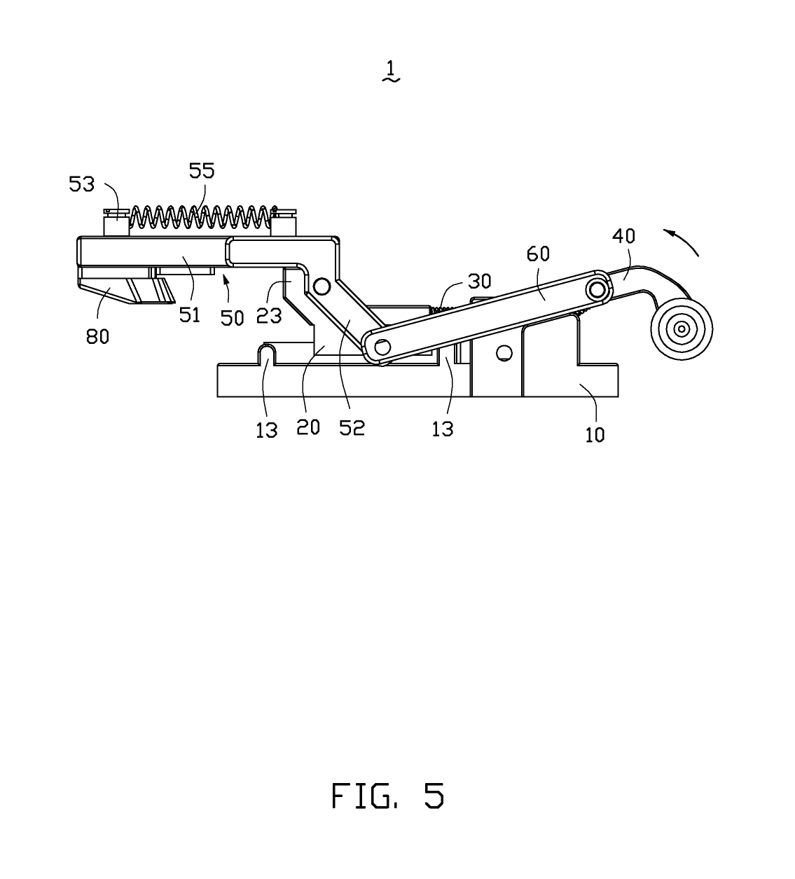

FIGS. 4 and 5 show that when the handle 40 is further manually rotated away from the rotatable member 50, the connecting bars 60 pulls the rotatable member 50 and the movable member 20 to move together on the base member 10, along the direction as indicated by the arrow of FIG. 4, and the first resilient element 30 is correspondingly compressed. Thus, the positioning head 80s of the four stretching devices 1 can stretch the four corners of the elastic ring to predetermined positions, thereby assembling the elastic ring into the electronic device.

FIG. 5 shows that the second top surface 160 of the base member 10 abuts against the handle 40 and can thus prevent the handle 40 from being further rotated, and the first bar 42 is substantially parallel to the connecting bar 60, thereby preventing the handle 40 from being rotated as driven the second resilient element 70.

When the handle 40 is rotated toward the rotatable member 50, counterclockwise (as indicated by the arrow of FIG. 5) and then is released, the first bar 42 becomes oblique to the connecting bar 60, and the first resilient element 30 and the second resilient element 70 restore to respectively drive the movable member 20 and the handle 40 back to their original positions as shown in FIG. 3.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A stretching device for moving one end of an elastic ring to a predetermined position, the stretching device comprising:
a base member;
a handle comprising at least one first bar, a first end of the at least one first bar being rotatably connected to the base member;
a movable member slidably mounted on the base member and comprising a blocking section opposite to the base member;
a rotatable member comprising at least one second bar, a first end of the at least one second bar being rotatably connected to the movable member;
at least one connecting bar with opposite ends rotatably connected to a second end of the at least one first bar and a second end of the at least one second bar, respectively; and
a positioning head fixed to the rotatable member;
wherein when the handle is manually rotated away from the rotatable member, the at least one connecting bar is configured to drive the rotatable member to rotate with respect to the movable member to a position where the rotatable member abuts against a top surface of the movable member, thereby causing the positioning head to engage one end of the elastic ring; and
when the handle is further rotated away from the rotatable member, the at least one connecting bar is configured to drive the rotatable member and the movable member to slide together on the base member, thereby allowing the positioning head to move the end of the elastic ring to a predetermined position.

2. The stretching device as described in claim 1, wherein the base member comprises a base portion and a sliding bar protruding from the base portion, and the movable member defines a sliding groove receiving the sliding bar of the base member.

3. The stretching device as described in claim 2, wherein the movable member further comprises a plurality of limiting blocks protruding from the base portion and adjacent to opposite ends of the sliding bar for preventing the movable member from moving on the base member.

4. The stretching device as described in claim 1, wherein the movable member comprises at least one guide pin, and the base member comprises a base portion and at least one support plate protruding from the base portion and each defining a guide hole for the extension of the at least one guide pin.

5. The stretching device as described in claim 4, further comprising at least one first resilient element with opposite ends abutting against the movable member and the at least one support plate.

6. The stretching device as described in claim 5, wherein the at least one first resilient element is a spring coil coiled around the at least one guide pin.

7. The stretching device as described in claim 4, further comprising a second resilient element with opposite ends connected to the handle and the at least one support plate respectively, thereby driving the handle to rotate back to its original position.

8. The stretching device as described in claim 7, wherein the base member comprises a fixing rod extending through the at least one support plate and defining an annular first fixing slot, and the second resilient element is a spring coil with one end fixedly retained within the first fixing slot and the second fixing slot.

9. The stretching device as described in claim 1, wherein the base member comprises a base portion and at least one limiting plate protruding from the base portion, and the at least one limiting plate comprises a top surface for preventing the second bar from rotating with respect to the base member.

10. The stretching device as described in claim 1, wherein when the handle is rotated to a position where the top surface of the movable member abuts against the second bar, the first bar of the handle is substantially parallel to the connecting bar.

11. The stretching device as described in claim 1, wherein the rotatable member comprises a top plate connected to the second bar, a first positioning post slidably connected to the top plate, and a third resilient element with opposite ends connected to the top plate and the first positioning post respectively, and the positioning head is fixed to the first positioning post.

12. The stretching device as described in claim 11, wherein the top plate defines a through slot for the extension of the first positioning post, and the positioning head is fixed to one end of the first positioning post that extends through the through slot.

13. The stretching device as described in claim 12, wherein the top plate further defines a sliding channel communicating with the through slot, and the positioning head is slidably received in the sliding channel.

14. The stretching device as described in claim 13, wherein a cross section of the sliding channel is T-shaped.

15. The stretching device as described in claim 11, wherein the rotatable member further comprises a second positioning post fixed to the top plate and substantially aligned with the first positioning post, and one end of the third resilient element is fixed to the second positioning post.
